(19) United States
(12) Patent Application Publication
(10) Pub. No.: US 2016/0062655 A1
(43) Pub. Date: Mar. 3, 2016

(54) System and Method for Improved Memory Allocation in a Computer System

(71) Applicant: Endgame, Inc., Atlanta, GA (US)

(72) Inventors: Gabriel D. LANDAU, Elkridge, MD (US); Zach Riggle, Drexel Hill, PA (US); Cody Pierce, Austin, TX (US)

(73) Assignee: Endgame, Inc.

(21) Appl. No.: 14/471,806

(22) Filed: Aug. 28, 2014

(51) Int. Cl. G06F 3/06

(52) U.S. Cl. CPC G06F 3/0604; G06F 3/0631; G06F 3/0673

(57) ABSTRACT

The present invention relates to a system and method for improved memory allocation in a computer system. The system and method reduces or eliminates vulnerabilities that would otherwise exist due to use-after-free situations involving memory, thereby enhancing the security of the computer system.

### FIELD OF THE INVENTION

The present invention relates to a system and method for improved memory allocation in a computer system. The system and method reduces or eliminates vulnerabilities that would otherwise exist due to use-after-free situations involving memory, thereby enhancing the security of the computer system.

### BACKGROUND OF THE INVENTION

Existing prior art computer systems sometimes experience a use-after-free situation. This occurs when a certain portion of memory is allocated to a first pointer and later that portion of memory is freed and allocated to a second pointer. If the first pointer then attempts to access that same portion of memory, a contention problem arises due to the first pointer and second pointer both referencing the same portion of memory. If one pointer changes the values stored in that portion of memory, the memory will be corrupted as to the other pointer.

The use-after-free situation also results in a vulnerability to attack by computer viruses, malware, and other techniques used by computer attackers. For example, an attacker can use the first pointer to change the value stored in the portion of memory, which may have negative consequences for the second pointer and its use by the computer system. This chain of events may give the attacker the ability to read from or write to arbitrary locations in memory or non-volatile storage or to gain the ability to execute code on the computer system (whereby the hacker can gain complete control of the system). Vulnerabilities that result from a use-after-free situation are significant when the two pointers are of different data types.

An example of a user-after-free situation that can sometimes arise in the prior art and the vulnerabilities that result from that situation are depicted in FIGS. 1-5. With reference to FIG. 1, a memory allocation system 100 is depicted. Pointer 110 points to a portion 130 of memory 120. Pointer 110 is defined as a data type of Type 1, and it stores data “ABC” of Type 1 in portion 130 or memory 120. Here, portion 130 can correspond to a range of addresses in memory 120 and is typically assigned by an allocator module within an operating system. Memory 120 optionally comprises Random Access Memory (RAM), flash memory, or other types of memory. Type 1 can be, for example, a first object. An object typically is a location in memory having a value and possibly referenced by an identifier. An object can be a variable, function, or data structure. In an object-oriented programming paradigm, an object is a particular instance of a class where the object can be a combination of variables, functions, and data structures.

With reference to FIG. 2, portion 130 of memory is freed and thereafter can be allocated for other purposes.

With reference to FIG. 3, pointer 140 is defined as a data type of Type 2, and it stores data “123” of Type 2 in portion 130 of memory 120. Type 2 can be, for example, a second object different than the first object.

With reference to FIG. 4, pointer 110 is again used, either due to poor design, human error, or because of an attack. Pointer 110 and pointer 140 now point to the same portion 130 of memory 120.

With reference to FIG. 5, pointer 110 now changes the value stored in portion 130 of memory 120, such that portion 130 now stores the value “DEF” of Type 1. This can have extremely negative effects because Pointer 140 is now pointing to the value “DEF” as well. When the computer system executes other instructions with pointer 140 pointing to the value “DEF,” a hacker may potentially gain the ability to read from or write to arbitrary locations in memory or non-volatile storage or to gain the ability to execute code on the computer system (thereby gaining complete control of the system).

A simplified example of code and events that result in an attacker taking advantage of a use-after-free situation is the following:
1. pointerA=new Object A( )
2. altPointer A=pointerA
3. delete pointerA
4. pointerA=NULL
5. pointer=new Object B( ) (Assume that the allocator allocates new Object B to same address as recently deleted ObjectA)
6. Attacker controls altPointerA and pointerB

The prior art includes certain attempts by designers of a particular software program to minimize or reduce vulnerabilities caused by free-after-use situations within that particular software program. For example, Mozilla Firefox is designed so that memory is allocated in such a way that pointers of different types are never allocated to the same portion of memory by the Mozilla Firefox code. This makes it much more difficult for hackers to take advantage of a use-after-free situation, since they are unable to use a pointer of one type to change values in memory that are accessed by a pointer of a different type. However, Mozilla Firefox only provides protections for its own use of memory.

To date, no system or method exists that can protect against vulnerabilities resulting from use-after-free situations for all programs or applications using the operating system memory allocator. Thus, in prior art systems, unless a program or application has a specific built-in design for protecting against such vulnerabilities, the computer system as a whole still will be vulnerable to attack.

What is needed is a system and method for reducing or eliminating vulnerabilities resulting from a user-after-free situation as to all programs or applications running on a computer system.

### BRIEF SUMMARY OF THE INVENTION

The embodiments comprise a system and method for intervening whenever code wishes to allocate a portion of memory, for creating pools of memory, and for allocating a different pool to each type of pointer.

### BRIEF DESCRIPTION OF THE DRAWINGS

FIG. 1 depicts a prior art system and method for allocating a portion of memory for a first pointer.

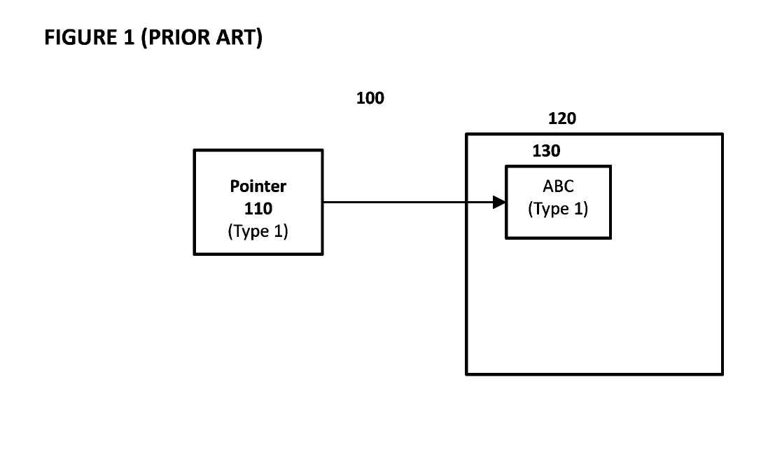

FIG. 2 depicts a prior art system and method for freeing the portion of memory.

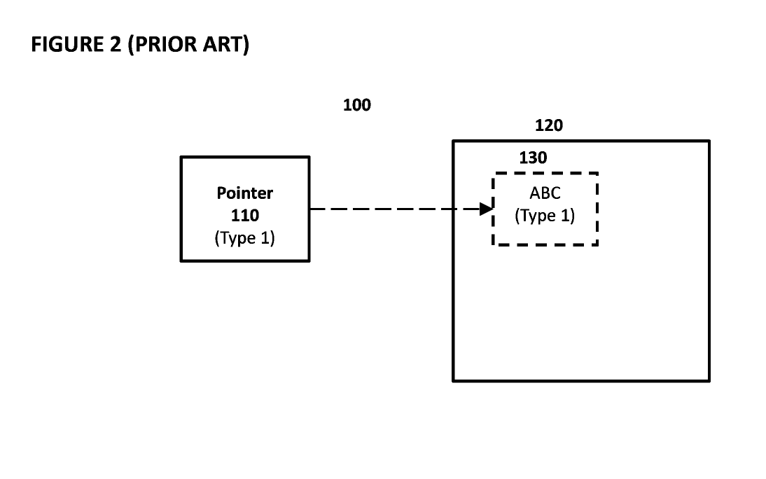

FIG. 3 depicts a prior art system and method whereby the portion of memory is allocated to a second pointer.

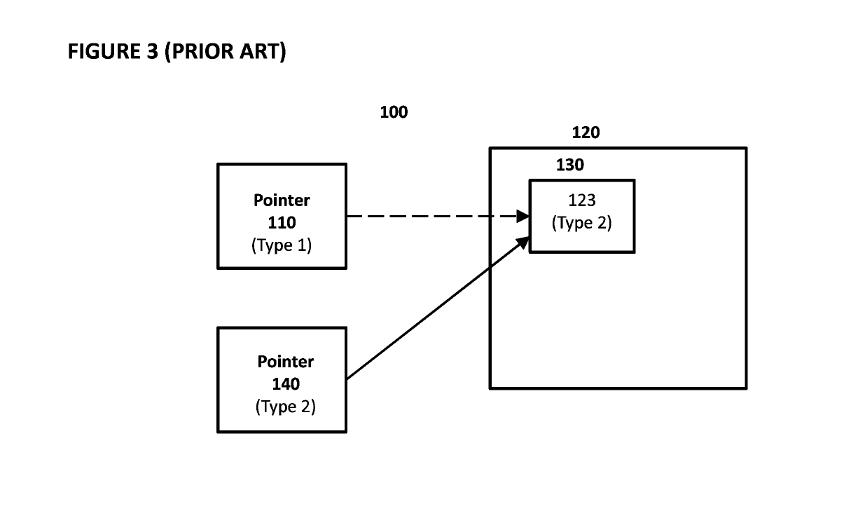

FIG. 4 depicts a prior art system and method where the first pointer and second pointer are pointing to the same portion of memory.

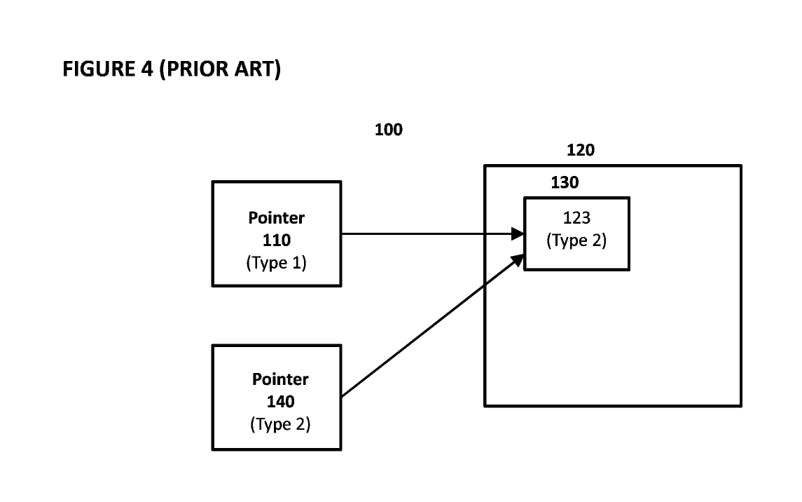

FIG. 5 depicts a prior art use-after-free situation where the first pointer changes the value stored in the portion of memory to which the second pointer is pointing.

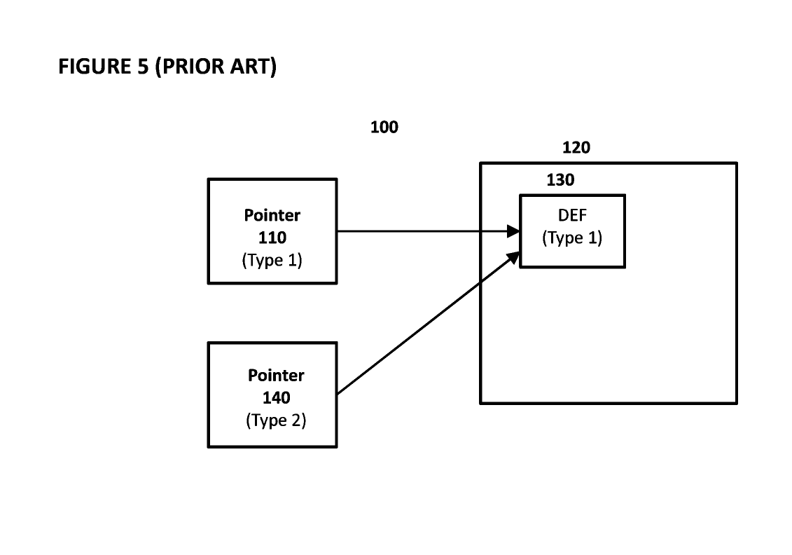

FIG. 6 depicts an aspect of an embodiment of a memory allocation engine.

FIG. 7 depicts another aspect of an embodiment of a memory allocation engine.

FIG. 8 depicts another aspect of an embodiment of a memory allocation engine.

FIG. 9 depicts another aspect of an embodiment of a memory allocation engine.

FIG. 10 depicts another aspect of an embodiment of a memory allocation engine.

FIG. 11 depicts certain hardware components of a computer system utilizing a memory allocation engine.

FIG. 12 depicts certain software components of an embodiment of a computer system utilizing a memory allocation engine.

FIG. 13 depicts a method of memory allocation in a computer system.

FIG. 14 depicts a method of allocating a heap request to a memory pool.

FIG. 15 depicts certain software components of another embodiment of a computer system utilizing a memory allocation engine.

### DETAILED DESCRIPTION OF THE INVENTION

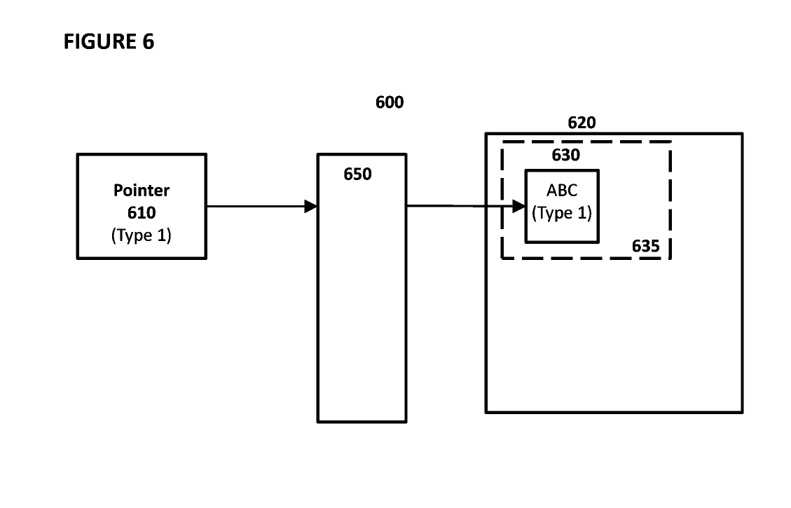

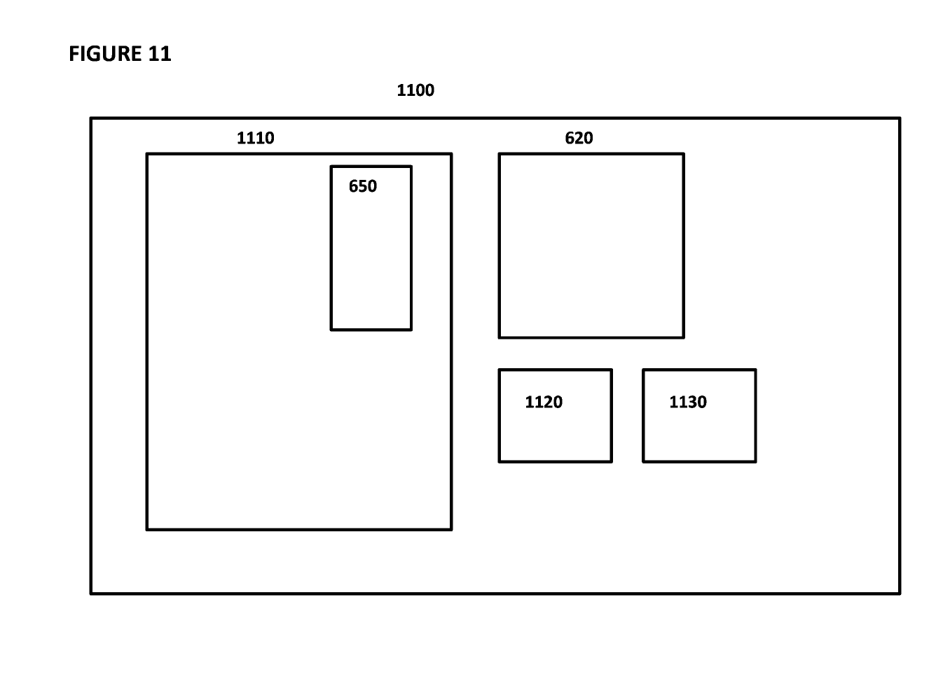

FIG. 6 depicts a memory allocation system 600 within computer system 1100 (depicted in FIG. 11 but not FIG. 6) that reduces or eliminates vulnerabilities that would otherwise exist due to use-after-free situations. Memory allocation system 600 comprises memory 620 and memory allocation engine 650. Memory allocation engine 650 comprises lines of code executed by processor 1110 of computer system 1100 (depicted in FIG. 11).

Memory allocation engine 650 intervenes whenever programs, applications, or other code attempts to allocate a portion of memory through a heap request. A heap request is a request for the allocation of memory from a pool of memory available to a program or process.

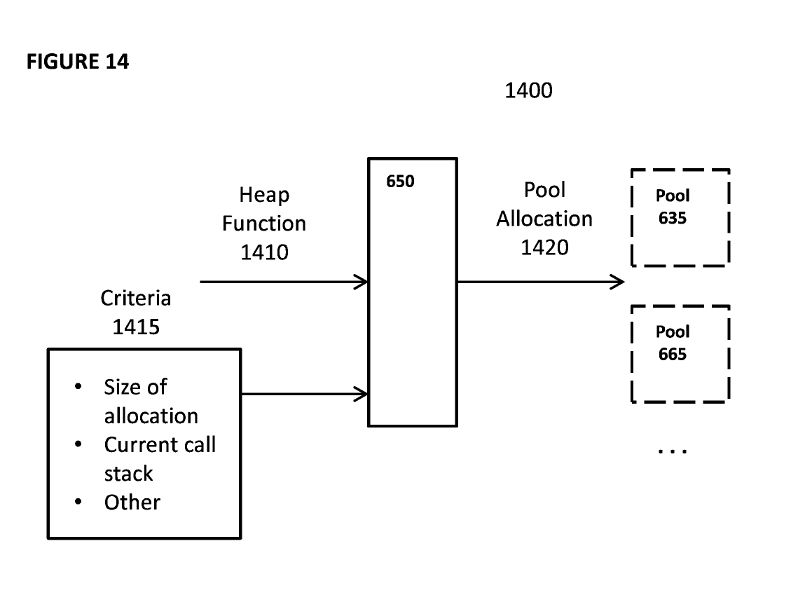

For example, in FIG. 6, pointer 610 of data type Type 1 would normally cause the operating system memory allocator to allocate a portion of memory 620 to pointer 610. In this embodiment, however, memory allocation engine 650 intervenes and manages the allocation. In this example, memory allocation engine 650 creates pool 635 within memory 620 using the method described below with reference to FIG. 14 and defines pool 635 as being a pool to store data only for pointers of Type 1. Pool 635 corresponds to a set or range of addresses within memory 620. Memory allocation engine 650 allocates portion 630 within pool 635 to pointer 610. Thereafter, pointer 610 can store the data “ABC” of Type 1 in portion 630.

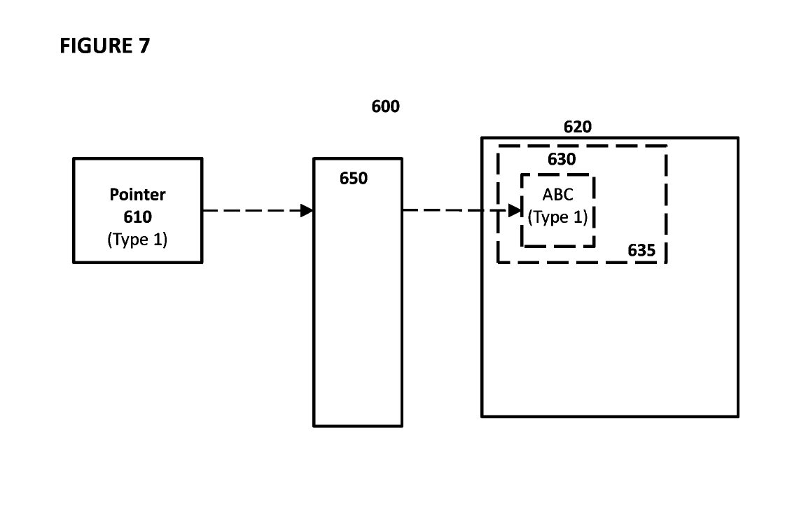

With reference to FIG. 7, at a later time, portion 630 is freed, as might happen, for example, if a function such as “free” or “delete” is invoked to free pointer 610. This means that portion 630 can be allocated for other purposes.

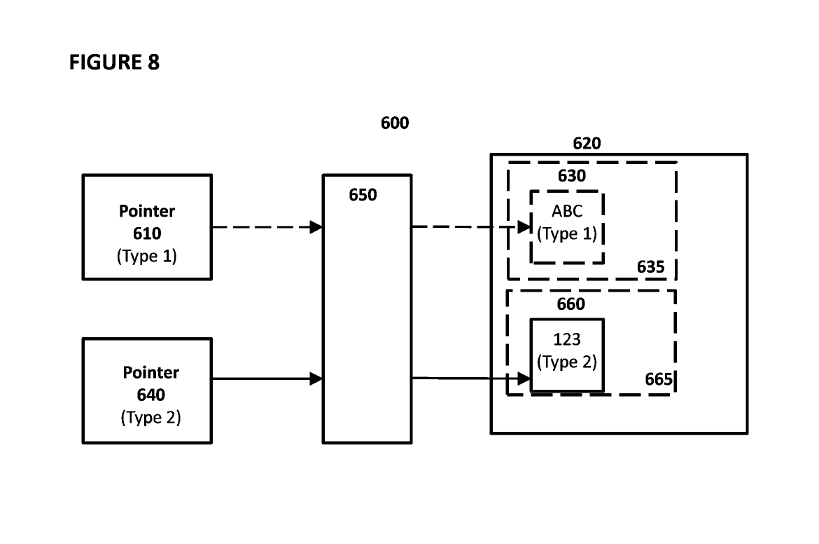

With reference to FIG. 8, pointer 640 of Type 2 would normally cause the operating system memory allocator to allocate a portion of memory 620. Memory allocation engine 650 intervenes and manages the allocation. In this example, memory allocation engine 650 creates pool 665 within memory 620 using the method described below with reference to FIG. 14 and defines pool 665 as being a pool to store data only for pointers of Type 2. Pool 665 corresponds to a set or range of addresses within memory 620. Notably, the set or range of addresses assigned to pool 635 and pool 665 do not overlap. Memory allocation engine 650 allocates a portion 660 within pool 665 to pointer 640. Thereafter, pointer 640 can store the data “123” of Type 2 in portion 660.

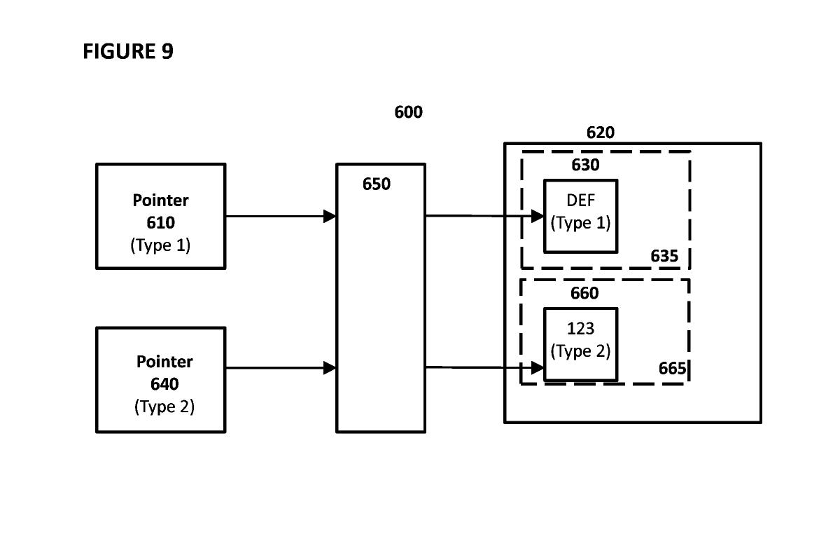

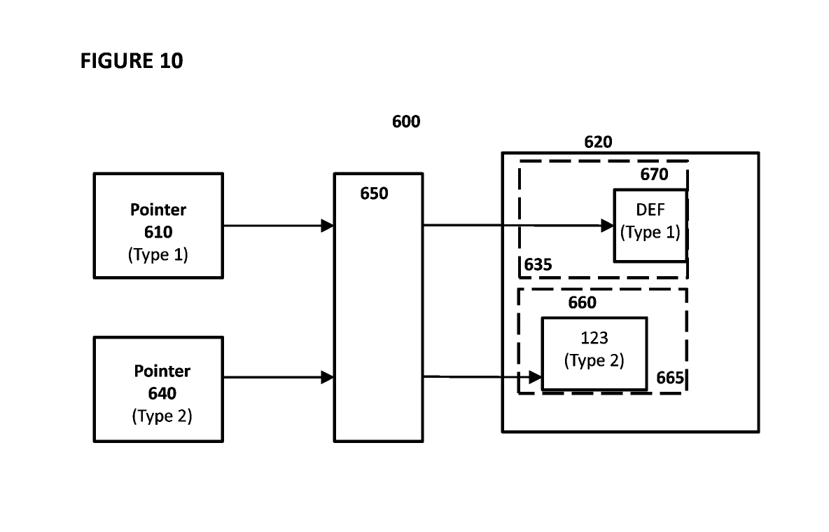

With reference to FIG. 9, if pointer 610 then invoked again (for example, due to an attack), then a use-after-free situation would arise. In this situation, memory allocation engine 650 might allocate portion 630 to pointer 610 again. In the alternative, with reference to FIG. 10, memory allocation engine 650 can allocate portion 670 to pointer 610. In either situation, pointer 640 has not been corrupted, and the data “123” stored in portion 660 is still intact. Notably, the only other pointers that potentially could also be assigned to portion 630 or portion 670 at that time would be pointers of Type 1, due to the creation and definition of pool 635 as storing data only for pointers of Type 1. Thus, in memory allocation system 600, use-after-free situations would never result in pointers of two different types pointing to the same portion of memory 620. Unlike the prior art systems, the embodiments of FIGS. 6-10 are not vulnerable to attack based on a use-after-free situation involving pointers of different types.

With reference to FIG. 11, computer system 1100 comprises processor 1110, memory 620, non-volatile storage 1120, and network interface 1130. Non-volatile storage 1120 can comprise a hard disk drive, optical disk drive, flash memory drive, or other non-volatile storage device. Network interface 1130 can comprise an interface for a hardwired network such as Ethernet or an interface for a wireless network such as Bluetooth or 802.11 (WiFi).

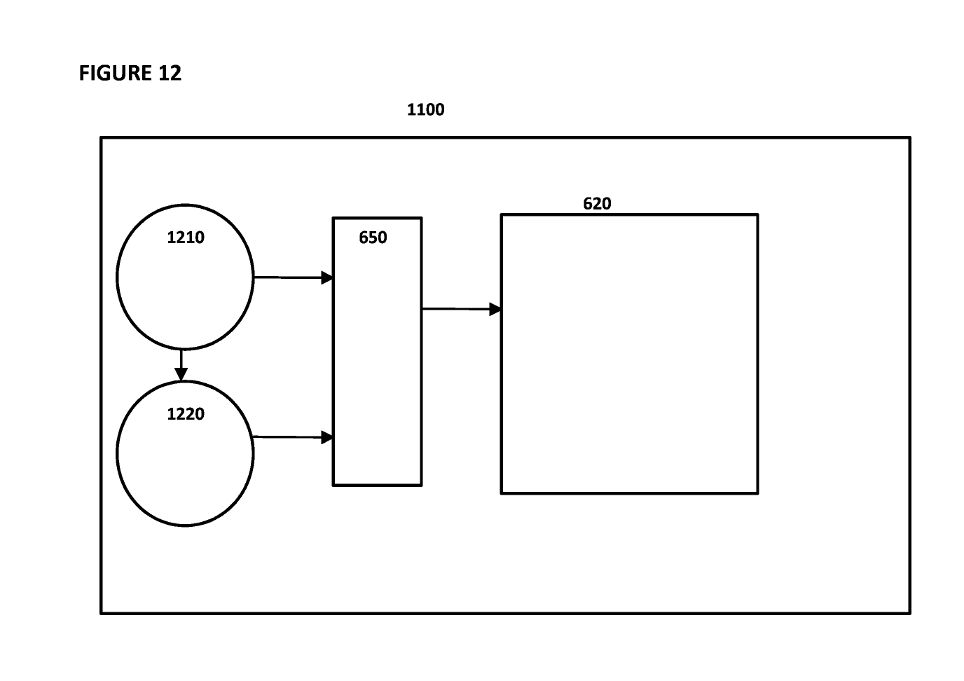

With reference to FIG. 12, software aspects of computer system 1100 are depicted. As in previous figures, memory allocation engine 650 interacts with memory 620. Memory allocation engine 650 also interacts with operating system 1220 and program or application 1210. Operating system 1220 can comprise a Microsoft Windows operating system, MacOS operating system, a UNIX or Linux system, or a mobile device operating system such as Android or iOS. Operating system 1220 comprises lines of code executed by processor 1110. Program or application 1210 comprises lines of code executed by processor 1110.

During operation, when program or application 1210 and/or operating system 1220 attempts to allocate a portion of memory 620, memory allocation engine 650 intervenes to create one or more pools within memory 620 and to allocate a portion of such a pool to the pointer for which memory is to be allocated.

In one embodiment, memory allocation engine 650 intervenes through the use of hooks into operating system 1220. For example, in many operating systems it is possible to hook all heap functions through the use of an external program. When implemented in such a system, memory allocation engine 650 will be invoked whenever a heap function is used by operating system 1220 or program or application 1210. If program or application 1210 executes a heap function, the heap function will invoke the memory allocation function of operating system 1220, which in turn will invoke memory allocation engine 650 due to the presence of the hooks.

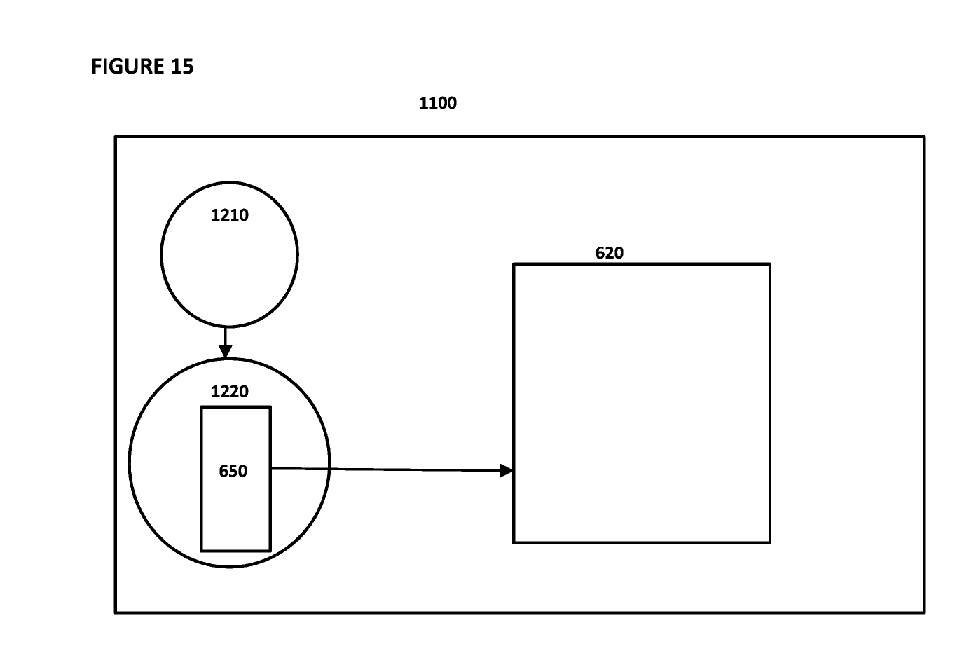

In another embodiment, with reference to FIG. 15, memory allocation engine 650 is built into operating system 1220, or is part of a code library that executes in conjunction with the operating system, and effectively acts as the memory allocator for operating system 1220. That is, operating system 1220 itself or in conjunction with a code library (through memory allocation engine 650) creates pools within memory and assigns pointers of different data types of different pools, in the same manner discussed previously with reference to FIGS. 6-10.

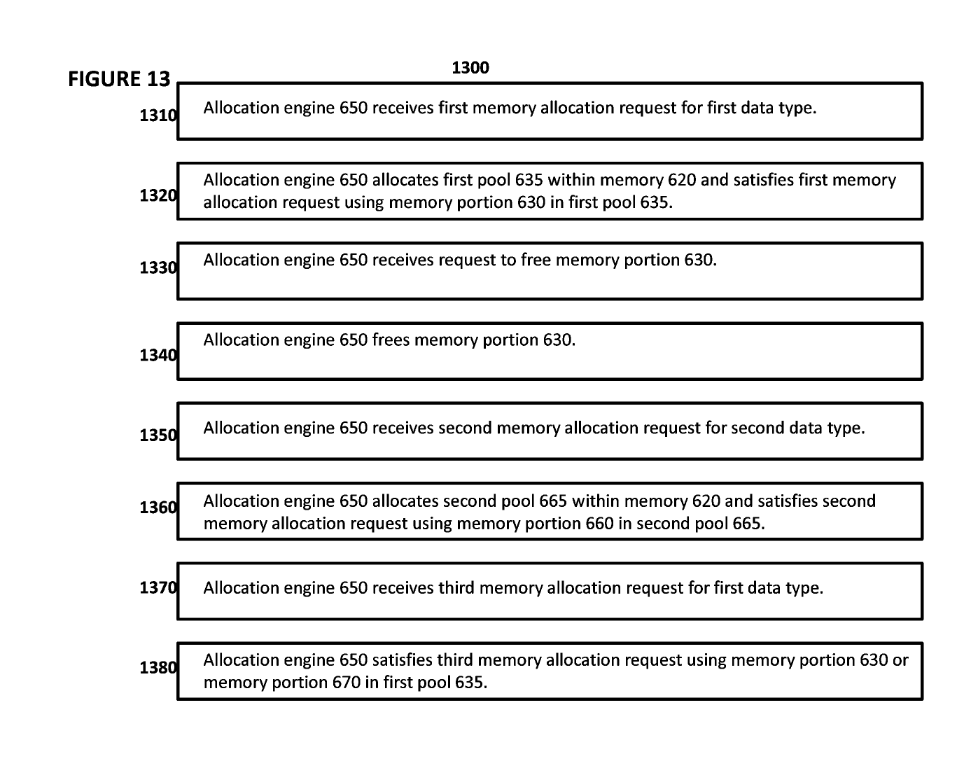

With reference to FIG. 13, a memory allocation method 1300 is depicted. Allocation engine 650 receives first memory allocation request for first data type (step 1310). Allocation engine 650 allocates first pool 635 within memory 620 and satisfies first memory allocation request using memory portion 630 in first pool 635 (step 1320). Allocation engine 650 receives request to free memory portion 630 (step 1330). Allocation engine 650 frees memory portion 630 (step 1340). Allocation engine 650 receives second memory allocation request for second data type (step 1350). Allocation engine 650 allocates second pool 665 within memory 620 and satisfies second memory allocation request using memory portion 660 in second pool 665 (step 1360). Allocation engine 650 receives third memory allocation request for first data type (step 1370). Allocation engine 650 satisfies third memory allocation request using memory portion 630 or memory portion 670 in first pool 635 (step 1380).

With reference to FIG. 14, a pool allocation method 1400 is depicted. Pool allocation method 1400 comprises memory allocation engine 650 receiving a heap function 1410 (which is an attempt or request for an allocation of memory 620) and performing pool allocation 1420, which comprises an assignment of a pool, such as pool 635, pool 665, or another pool (including the creation of a new pool) to the pointer associated with heap function 1410.

Memory allocation engine 650 performs the pool allocation using criteria 1415. In this example, criteria 1415 comprises: the size of the allocation requested by heap function 1410 (for example, the number of bytes) and the current call stack. An example of a call stack is the tuple of the function address that called the allocator, the function address that called that function, and so forth. The current call stack reflects the context in which the heap function 1410 is called. For example, memory allocation engine 650 can perform a hash function on the top N return addresses from the call stack (where N is an integer).

Criteria 1415 optionally can comprise a tuple of the criteria. In the above example, criteria 1415 would comprise a 2-tuple. Memory allocation engine 650 would assign a particular pool (such as pool 635) only to heap functions that are associated with the same tuple or criteria 1415. In the above example, only heap functions that were associated with identical size allocations and call stacks would be assigned to the same pool. If no existing pool exists for a given heap function, then memory allocation engine 650 creates a new pool, which thereafter will be assigned to heap functions that had the same criteria 1415 as that heap function. This eliminates or reduces the vulnerabilities that would otherwise exist due to use-after-free situations.

Memory allocation engine 650 can be used with any program or application 1210. Thus, even if program or application 1210 does not have built-in protections against attacks in use-after-free situations, memory allocation engine 650 can provide such protections. In the alternative, instead of using memory allocation engine 650 for all programs or applications 1210, computer system 1100 instead could provide a user interface that allows a user to select the particular programs or applications 1210 for which he or she wants memory allocation engine 650 to interact with. The user might elect to not use memory allocation engine 650 with every program or application 1210.

It is to be understood that the present invention is not limited to the embodiment(s) described above and illustrated herein, but encompasses any and all variations evident from the above description. For example, references to the present invention herein are not intended to limit the scope of any claim or claim term, but instead merely make reference to one or more features that may be eventually covered by one or more claims.

What is claimed is:

1. A computer system, comprising:
a processor executing a first set of code and a second set of code; and
a memory coupled to the processor for storing data;
wherein the first set of code comprises instructions to generate a first pool within the memory and a second pool within the memory, the first pool corresponding to a first set of addresses within the memory and the second pool corresponding to a second set of addresses within the memory, wherein the first set of addresses and the second set of addresses do not overlap, and wherein pointers of a first type within the second set of code are assigned to the first pool and pointers of a second type within the second set of code are assigned to the second pool.

2. The computer system of claim 1, wherein the pointers are assigned to the first pool or the second pool based on criteria comprising a current call stack.

3. The computer system of claim 2, wherein the criteria further comprises allocation size.

4. The computer system of claim 1, wherein the processor executes an operating system and the first set of code is invoked through a hook in the operating system.

5. The computer system of claim 1, wherein the operating system comprises a memory allocator, and the first set of code is invoked instead of the memory allocator to allocate memory to a pointer.

6. The computer system of claim 1, wherein the processor executes an operating system and the first set of code is part of the operating system.

7. The computer system of claim 1, wherein the processor executes an operating system and the first set of code is part of a code library that executes in conjunction with the operating system.

8. The computer system of claim 1, wherein the first type is a first object.

9. The computer system of claim 8, wherein the second type is a second object.

10. A method of allocating memory to a plurality of pointers within a computer system, comprising:
executing, on a processor, a first set of code;
executing, on the processor, a second set of code containing a first pointer of a first type and a second pointer of a second type different than the first type;
generating, by the processor executing the first set of code, a first pool within a memory and a second pool within the memory, the first pool corresponding a first set of addresses within the memory and the second pool corresponding to a second set of addresses within the memory, wherein the first set of addresses and the second set of addresses do not overlap; and
assigning, by the processor executing the first set of code, the first pointer to the first pool and the second pointer to the second pool.

11. The method of claim 10, wherein the assigning step is performed based on criteria comprising a current call stack.

12. The method of claim 11, wherein the criteria further comprises allocation size.

13. The method of claim 10, further comprising:
executing, on the processor, an operating system;
invoking, by the processor, the first set of code in response to a hook in the operating system.

14. The method of claim 13, wherein the operating system comprises a memory allocator, and the first set of code is invoked instead of the memory allocator.

15. The method of claim 10, further comprising: executing, on the processor, an operating system, wherein the first set of code is part of the operating system.

16. The method of claim 10, further comprising: executing, on the processor, an operating system, wherein the first set of code is part of a code library that executes in conjunction with the operating system.

17. The method of claim 10, wherein the first type is a first object.

18. The method of claim 17, wherein the second type is a second object.

19. A method of allocating memory to a plurality of pointers within a computer system, comprising:
executing, on a processor, a first set of code;
executing, on the processor, a second set of code containing a first pointer of a first type and a second pointer of a second type different than the first type;
generating, by the processor executing the first set of code, a first pool within a memory and a second pool within the memory, the first pool corresponding to a first set of addresses within the memory and the second pool corresponding to a second set of addresses within the memory, wherein the first set of addresses and the second set of addresses do not overlap;
assigning, by the processor executing the first set of code, the first pointer to the first pool and the second pointer to the second pool;
freeing, by the processor executing the second code, the first pointer;
executing, by the processor, code containing the first pointer; and
assigning, by the processor executing the first set of code, the first pointer to the first pool.

20. The method of claim 19, wherein both assigning steps are performed based on criteria comprising a current call stack.

21. The method of claim 20, wherein the criteria further comprises allocation size.

22. The method of claim 19, further comprising:
executing, on the processor, an operating system;
invoking, by the processor, the first set of code in response to a hook in the operating system.

23. The method of claim 22, wherein the operating system comprises a memory allocator, and the first set of code is invoked instead of the memory allocator.

24. The method of claim 19, further comprising: executing, on the processor, an operating system, wherein the first set of code is part of the operating system.

25. The method of claim 19, further comprising: executing, on the processor, an operating system, wherein the first set of code is part of a code library that executes in conjunction with the operating system.

26. The method of claim 19, wherein the first type is a first object.

27. The method of claim 26, wherein the second type is a second object.
